(19) United States
(12) Patent Application Publication
(10) Pub. No.: US 2025/0319392 A1
(43) Pub. Date: Oct. 16, 2025

(54) WI-FI NETWORK-BASED INTERACTIVE GAMING SYSTEM AND METHODS

(71) Applicant: PLUME DESIGN, INC., Palo Alto, CA (US)

(72) Inventors: Miroslav SAMARDZIJA, Mountain View, CA (US); Metod MEDJA, Ljubljana (SI); Gal TRAPECAR, Ljubljana (SI); Grigor RISTOV, Ljubljana (SI); Dariusz KOPKA, Warsaw (PL); Liem Hieu Dinh VO, San Jose, CA (US)

(21) Appl. No.: 18/632,576

(22) Filed: Apr. 11, 2024

(51) Int. Cl. A63F 13/327; A63F 13/216; A63F 13/533; A63F 13/5375; A63F 13/798; H04W 4/029; H04W 76/10; H04W 84/12

(52) U.S. Cl. CPC A63F 13/327; A63F 13/216; A63F 13/533; A63F 13/5375; A63F 13/798; H04W 4/029; H04W 76/10; H04W 84/12

(57) ABSTRACT

An interactive gaming system and methods are disclosed, utilizing Wi-Fi technology to transform a geolocation into a dynamic gaming environment. The system employs multiple Wi-Fi networks broadcasting distinct primary and secondary Service Set Identifiers (SSIDs). In some embodiments, the primary SSID is secured for network owner use, while the secondary SSID is designated for public access, broadcasting game-related data, or “nuggets.” A gaming application on user devices detects these secondary SSIDs, enabling players to connect and interact with virtual game elements. The system synchronizes with a central server or cloud service to manage game logic and player progress, leveraging geolocation data for location-based challenges. Wi-Fi configurations are optimized for stable gameplay data transmission, with signal strength data used by the system to determine the broadcast range of game elements. The system supports user-created games, updates leaderboards, pushes notifications, promoting physical activity and providing an immersive gaming experience.

### BACKGROUND

In the contemporary gaming landscape, the majority of popular games engage players in a physically passive manner, typically within indoor environments. This sedentary form of entertainment has contributed to an increase in obesity rates among children, now recognized as a leading health concern in the United States. Conventional gaming setups and the static nature of the interaction they provide do not promote physical activity, potentially leading to obesity or other chronic health conditions.

Acknowledging the transient popularity of physically interactive games like “Pokemon Go”, it becomes evident that while these games initially encourage outdoor activity, their appeal is not sustained. A contributing factor to their decline is the restricted game environment, which is under the unilateral control of the game company, limiting players' influence over their play environment.

### SUMMARY

To address the issue of engagement and physical activity in gaming, among others, a novel gaming system is proposed, leveraging Wi-Fi technology to create an active and dynamic gaming experience. The system described herein includes a robust infrastructure of Wi-Fi networks, utilizing both primary and secondary Wi-Fi signals broadcasted from routers and/or access points.

In some embodiments, a primary Wi-Fi network is designated for homeowner use, ensuring privacy and security for personal data. In some embodiments, a secondary Wi-Fi network serves a dual purpose: providing connectivity for guests and customers, and acting as a backbone for the innovative gaming system described herein. By reserving the secondary network for gaming, the system can broadcast game-related data, referred to as “nuggets”, without compromising the integrity and performance of the primary network.

In some embodiments, these “nuggets” include virtual items and/or objectives that players can interact with. They are advertised over the secondary Wi-Fi network as unique Service Set Identifiers (SSIDs), discoverable by participants of the gaming system. Participants, through a dedicated application such as HomePass®, a product of Plume Design, Inc®., can connect to these SSIDs, which corresponds to collecting a nugget or interacting with an element of the game. This engagement not only encourages physical movement as players traverse the network's range to find nuggets but also presents a dynamic gaming environment that changes in real-time based on players' locations and actions.

The gaming system capitalizes on the omnipresent nature of Wi-Fi networks in urban settings, turning cities into large-scale game boards where players' movements between different Wi-Fi nodes—homes, businesses, public spaces—translate into in-game actions. Each connection to a secondary network SSID represents a game action, be it collecting an item, completing a challenge, or unlocking a new game level.

The versatility of this Wi-Fi based gaming system opens the door to a multitude of game types, from scavenger hunts to augmented reality experiences, all rooted in the physical movement of the player and real-time interaction with the gaming environment. The system thus serves a dual purpose: providing an immersive gaming experience while simultaneously encouraging physical activity and combatting the sedentary tendencies of traditional video games.

### DESCRIPTIONS OF THE DRAWINGS

The features, functionalities, and advantages of the disclosed gaming system leveraging Wi-Fi technology will become more apparent from the following detailed description and the accompanying drawings, in which reference characters refer to the same parts throughout the various views. The drawings are not necessarily to scale, with emphasis instead being placed upon illustrating the principles of the disclosed gaming system:

FIG. 1 is a block diagram illustrating various configurations of Wi-Fi networks designed for internet connectivity and adapted for use in the gaming system according to some embodiments of the present disclosure;

FIG. 2A is a schematic representation of a Wi-Fi network incorporating cloud-based management and connecting through various gateway devices to a modem/router linked to the internet, facilitating centralized control over multiple Wi-Fi networks for gameplay according to some embodiments of the present disclosure;

FIG. 2B introduces a distributed system in a tree topology within a Wi-Fi network, optimizing efficiency and signal coverage for gameplay in environments unsuitable for single access points, repeaters, or mesh networks according to some embodiments of the present disclosure;

FIG. 3 depicts a diagram outlining the basic components found in a game broadcast network, including access points, mesh nodes, repeaters, and other network devices configured to support the gaming system according to some embodiments of the present disclosure;

FIG. 4 illustrates a server with core components configured to support cloud-based Wi-Fi network management and optimization for various types of games according to some embodiments of the present disclosure;

FIG. 5 shows an infrastructure comprising access points configured to create a mesh network across a geological location, enabling the broadcast of game data for an interactive gaming experience according to some embodiments of the present disclosure;

FIG. 6 depicts an example of a Treasure Map/Hunt game where participants interact with a sequence of unique SSIDs representing clues, leading to a final treasure within the gaming system according to some embodiments of the present disclosure;

FIG. 7 illustrates a Patterned Routes game that allows players to create and follow geo-artistic patterns by connecting to a sequence of non-primary SSIDs assigned to various nodes within the gaming system according to some embodiments of the present disclosure;

FIG. 8 presents a non-limiting example of a leaderboard displaying player achievements and rankings within the gaming system according to some embodiments of the present disclosure;

FIG. 9 shows a non-limiting user device in the form of a smartphone with a GUI displaying a leaderboard for one or more games described herein according to some embodiments of the present disclosure; and

FIG. 10 is a flowchart depicting one or more algorithmic steps implemented by the system to enable a variety of Wi-Fi-based games, illustrating the process from initializing the gaming infrastructure to managing and monitoring Wi-Fi network performance according to some embodiments of the present disclosure.

### DETAILED DESCRIPTION

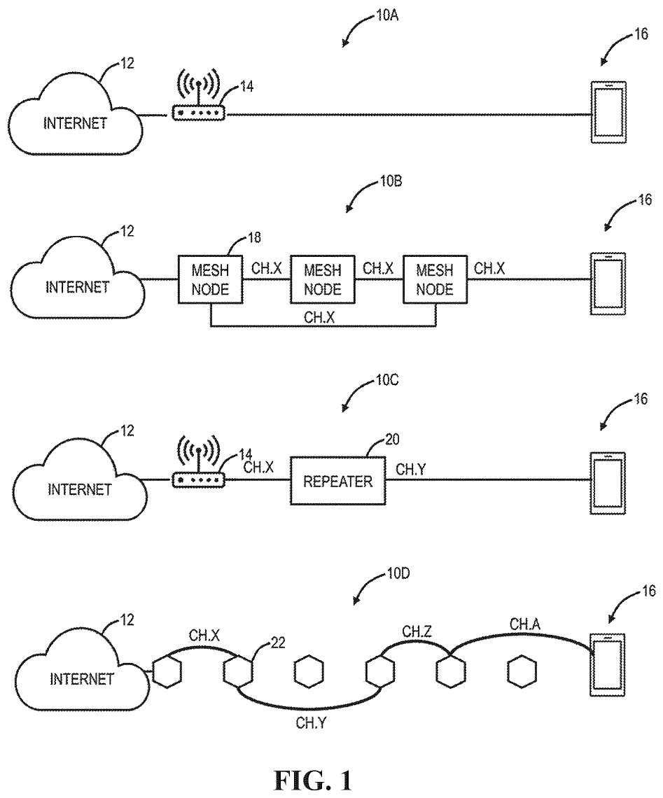

Illustrated in FIG. 1, the system includes various configurations of Wi-Fi networks 10 (specifically, networks 10A-10D) designed for internet connectivity, denoted as Internet 12. These networks adhere to IEEE 802.11 protocols and their variants to provide coverage across different physical locations such as homes, businesses, stores, libraries, schools, parks, etc. The primary difference among these network topologies lies in their coverage extent.

As used herein, the term Wi-Fi network 10 may include physical Wi-Fi networks and/or cloud-based Wi-Fi systems. Similarly, components such as access points 14, mesh nodes 18, repeaters 20, and devices 22 are collectively referred to as nodes or Wi-Fi nodes. The primary goal of these components is to facilitate network access to Wi-Fi client devices 16, hereafter mentioned as client devices or Wi-Fi devices, for the purposes of playing geolocation based games. It's understood by those with relevant expertise that Wi-Fi client devices 16 encompass a wide range of electronics, including mobile devices, tablets, computers, consumer electronics, home entertainment systems, televisions, IoT devices, and/or any device capable of network connectivity.

FIG. 1 shows various non-limiting network architectures used by the system according to some embodiments. For example, network 10A is characterized by a singular access point 14, situated to serve all Wi-Fi client devices 16 within its vicinity. In some embodiments, access point 14 may operate on one or more channels to accommodate bandwidth needs, such as providing specific channels to enable the games described herein according to some embodiments. In some embodiments, Network 10B employs a Wi-Fi mesh setup to address some challenges posed by a single access point setup. Network 10B may include multiple mesh nodes 18, creating a highly interconnected network that shares a common channel across all nodes and client devices, thereby facilitating various pathways for game data transmission.

In some embodiments, Network 10C includes a topology wirelessly connecting an access point 14 to a Wi-Fi repeater 20, allowing direct communication between them and the Wi-Fi client devices on distinct channels. This configuration addresses the channel-sharing drawback of mesh networks by allowing different communication bands for data hops, enhancing Wi-Fi speed. In some embodiments, one or more repeaters are configured to broadcast distinct SSIDs from the access point 14, making them appear as separate networks to client devices playing one or more games described herein.

System performance issues may occur, especially with real-time media applications which demand high throughput, low latency, and stable connections. Wi-Fi performance is generally hindered by three main factors: interference, congestion, and coverage. Interference becomes a significant issue as the number of Wi-Fi networks increases, with overlapping networks affecting each other's throughput. Congestion within a single network, particularly when handling multiple high-demand applications, can saturate the network's capacity.

In some embodiments, the system is configured to assign one or more access points 14, nodes 18, and/or Wi-Fi repeaters 20 as a game broadcaster. In some embodiments, the system includes one or more game broadcasters outside of a physical structure. In some embodiments, one or more game broadcasters are configured to broadcast a signal a predetermined distance outside of a structure from inside a structure. However, coverage issues can arise as Wi-Fi signals weaken over distance and when passing through physical barriers, leading to unreliable service in some parts of a home or building. These coverage issues may prevent gaming signals comprising game data from being broadcast a certain distance outside a physical structure. In some embodiments, a user may need to be present to receive a game signal using a client device, such as a cellular phone.

To improve Wi-Fi performance, two primary strategies have been explored within networks 10A, 10B, and 10C. The first involves enhancing single access points to strengthen signal coverage and increase data rates. However, this approach faces limitations due to regulatory restrictions on transmission power and the physical laws governing signal propagation. Despite significant efforts, such enhancements may not effectively extend signal through additional barriers.

The second strategy utilizes repeaters or mesh networks to extend Wi-Fi coverage more efficiently. Placing even a single repeater or using a mesh network can significantly reduce signal attenuation caused by physical barriers, offering a more effective solution for expanding coverage. Network 10D exemplifies a tree topology, allowing both wired and wireless interconnectivity among various Wi-Fi devices, differing from the previous configurations by enabling multiple wireless hops and channel use. This setup avoids or minimizes interference and congestion by employing multiple Wi-Fi channels for communication, enhancing network performance. In some embodiments, the system may include any combination of network architectures as the games described herein rely on different locations to encourage a user to engage in physical activity to play a game.

In some embodiments, the system is configured to determine a maximum broadcast distance by comparing Wi-Fi signal strength at a client device (e.g., cellular phone) to the client device's geolocation, which may be determined using conventional methods such as a global positioning system (GPS) or triangulation. In some embodiments, the system is configured to collect and store signal strength data from a plurality of Wi-Fi networks. This data may be obtained by recording Wi-Fi access signals from client devices connected to the network while users are moving throughout an area. In some embodiments, this allows the system to pre-determine locations outside of physical structures and/or in publicly accessible areas that are suitable to establish game broadcast nodes. In some embodiments, the system is configured to generate an overlay for a map (e.g., Google Maps®) comprising available broadcast nodes for one or more games. In some embodiments, the system is configured to enable a user to create a game, path, and/or nuggets, where the system allows the user to share a game and/or game feature with one or more other players.

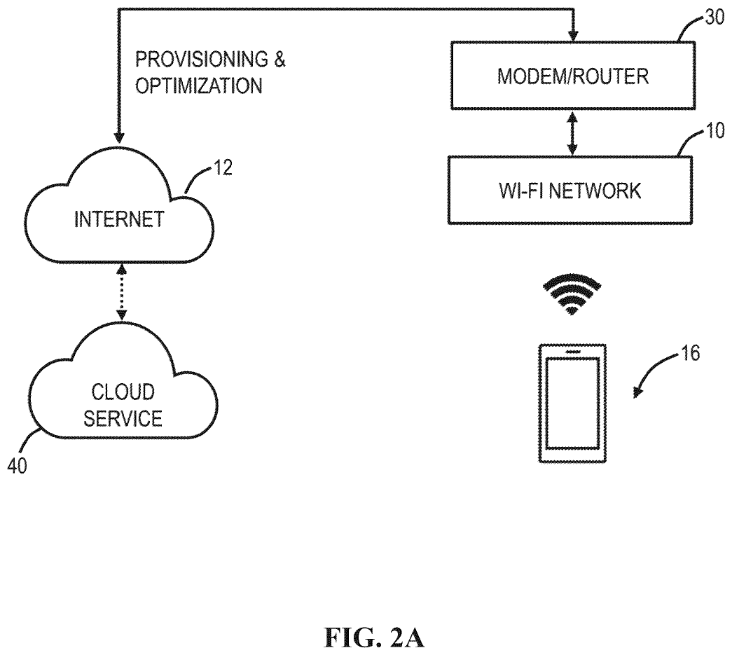

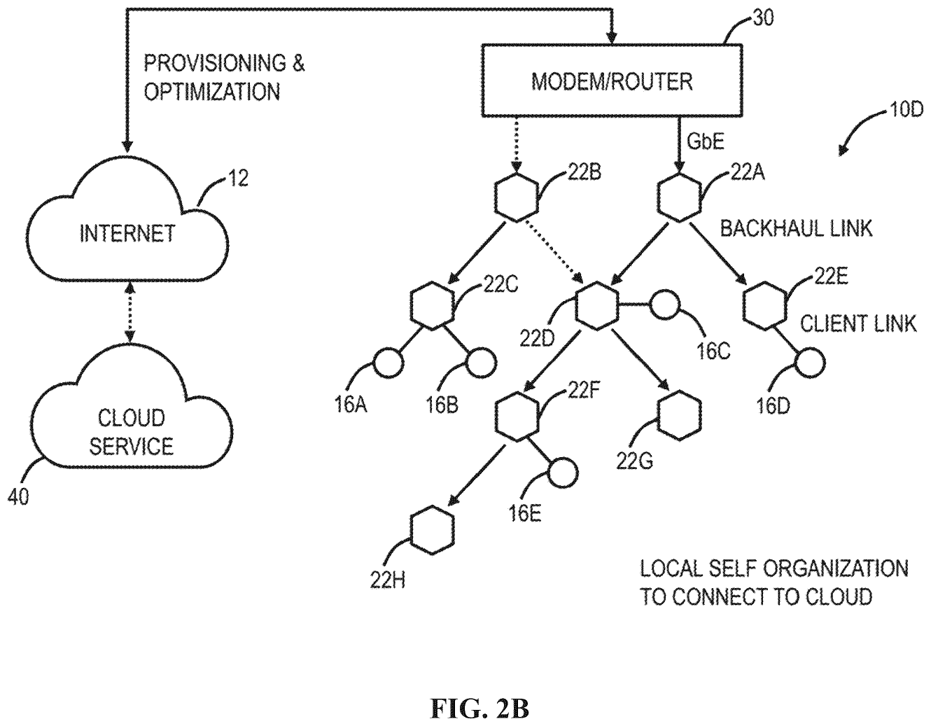

As illustrated in FIG. 2A, in some embodiments, the Wi-Fi network 10 incorporates cloud-based management, connecting through a gateway device such as access points 14, mesh nodes 18, or Wi-Fi devices 22 to a modem/router 30 linked to the internet. This setup enables centralized control over multiple Wi-Fi networks via a cloud service 40 accessible online, enhancing network management for gameplay through data analysis and node configuration based on collected measurements, such as signal strength recorded from various client devices. Unlike traditional local setups, this cloud-based approach standardizes interactions between devices and the cloud by using a cloud-agnostic platform for managing home connectivity services.

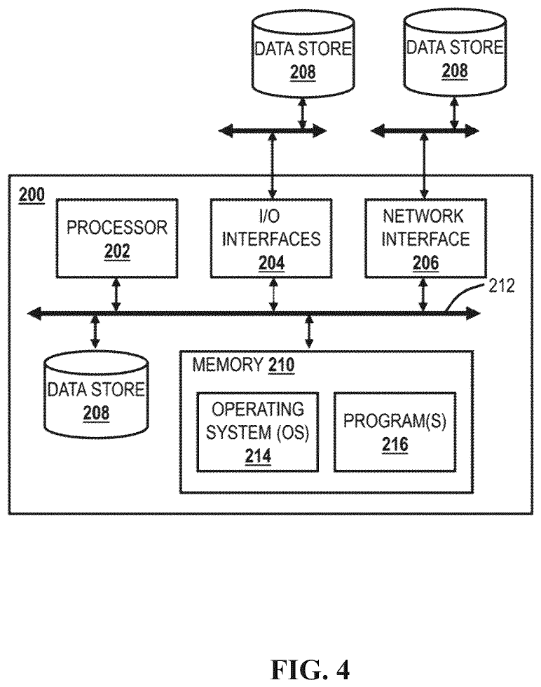

Cloud-based control, compatible with various Wi-Fi network configurations, such as those shown in FIGS. 4-7, leverage cloud computing for efficient resource management, enabling scalable and on-demand network access with minimal manual intervention. This method simplifies game application delivery and maintenance, moving away from traditional client-server models towards a centralized cloud-based system, which streamlines game application updates and leaderboard tracking across client devices.

FIG. 2B introduces network 10D as a distributed system in a tree topology, optimizing for efficiency in environments unsuitable for single access points, repeaters, or mesh networks. By deploying multiple access points throughout a location, this network ensures strong signal coverage and high-quality connectivity for all client devices, minimizing the distance and physical barriers each signal must overcome for gameplay. However, coordinating a large number of access points requires centralized management, which may use cloud-based solutions, to ensure optimal network performance and accessibility.

In optimizing coverage, the distributed Wi-Fi network faces challenges in ensuring all access points work harmoniously. Cloud-based control offers a solution by allowing remote configuration and management, facilitating efficient communication and coordination among access points and client devices. This approach contrasts with traditional methods, emphasizing the importance of cloud integration for advanced network management.

In some embodiments, the access points within the distributed network are capable of both wired and wireless connections, supporting a variety of connectivity options to enhance network flexibility and reliability. This infrastructure enables efficient data transmission paths and supports a diverse range of client devices, highlighting the advantages of a distributed Wi-Fi network over conventional mesh or repeater-based systems for gameplay.

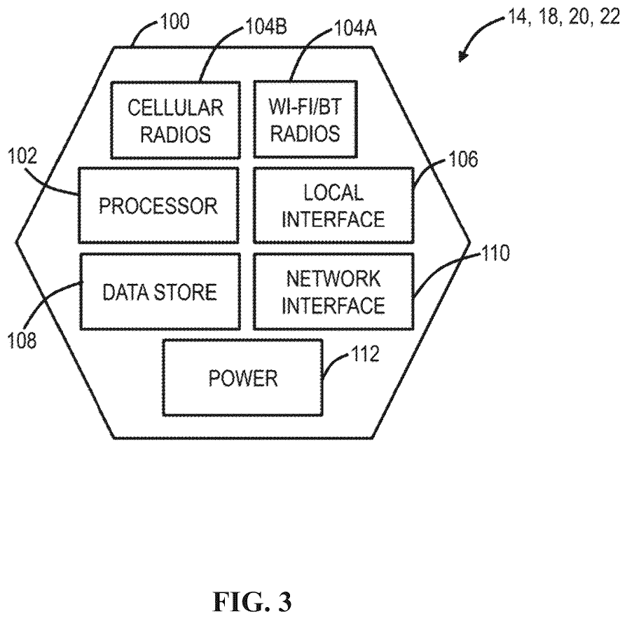

The diagram in FIG. 3 outlines the basic components found in a game broadcast network which includes one or more access points 14, mesh nodes 18, repeaters 20, etc., collectively referred to as a “node,” within one or more Wi-Fi networks 10. In some embodiments, one or more nodes include a compact physical form factor 100 housing one or more of a processor 102, multiple radios 104A, 104B, a local interface 106, a data storage unit 108, a network interface 110, and a power supply 112. FIG. 3 simplifies the actual complexity of such nodes, which in practice might include additional components and sophisticated processing logic to support both the described functionalities and other standard or advanced features not detailed herein.

The form factor 100 is designed for straightforward plug-in installation into an electrical outlet, supporting the widespread deployment of nodes across various premises. The processor 102 serves as the operational brain, executing software instructions for network management, data communication, and general operational control based on the embedded software within the data store 108 or memory. The processor's design allows it to handle both general-purpose tasks and those optimized for mobile or power-efficient applications.

In some embodiments, the dual radios 104A and 104B enable the node to communicate over Wi-Fi and cellular networks, respectively, adhering to standards like IEEE 802.11 for Wi-Fi and various cellular technologies for mobile connectivity. These radios play a role in managing a node's connections across different network types, supporting a wide range of communication requirements. The local interface 106 facilitates initial setup and ongoing communication with the node through a wired or wireless connection, including Bluetooth. This is especially useful during the node's initial integration into the Wi-Fi network, often requiring direct communication with a client device.

In some embodiments, storage 108 serves as the node's memory, storing operational data and software. This component can include a one or more volatile and nonvolatile (non-transitory) memory types, such as RAM and hard drives, tailored to the node's needs. The network interface 110 provides the node with a physical connection to the network, which could be essential for nodes that serve as connection points to the modem/router or support wired client devices.

The architecture of these nodes is designed to support not only the game functionalities described herein but also future advancements and integrations that may enhance network performance, reliability, and user experience outside of game play.

In some embodiments, the system includes one or more computers comprising one or more processors and one or more non-transitory computer readable media. In FIG. 4, the server 200, which may be used in conjunction with a Wi-Fi device and/or a client device, is depicted with its core components, including one or more processors 202, I/O interfaces 204, a network interface 206, data storage 208, and memory 210, interconnected via a local interface 212. This simplified representation underscores the server's capability to support a wide range of functionalities related to cloud-based Wi-Fi network management and optimization, potentially including additional components not specified here for different types of games.

The server's processor 202 processes instructions stored in memory 210 to manage data flow, network operations, and communication with other network components. I/O interfaces 204 facilitate interaction with external devices and users, while the network interface 206 enables the server to connect to and communicate over the internet or other networks, crucial for cloud-based services.

In some embodiments, data storage 208 offers a repository for operational data, software, and other information, supporting both volatile and nonvolatile memory to ensure data integrity and quick access when needed. Memory 210, comprising a range of storage media, allows the server to execute software and store operational data efficiently, supported by a distributed architecture that enhances system performance and reliability.

The system's use of multiple network configurations emphasizes flexibility, scalability, and efficient data management, aligning with the demands of modern cloud-based Wi-Fi networks and supporting a broad spectrum of services and applications to enhance user connectivity and network management during gameplay.

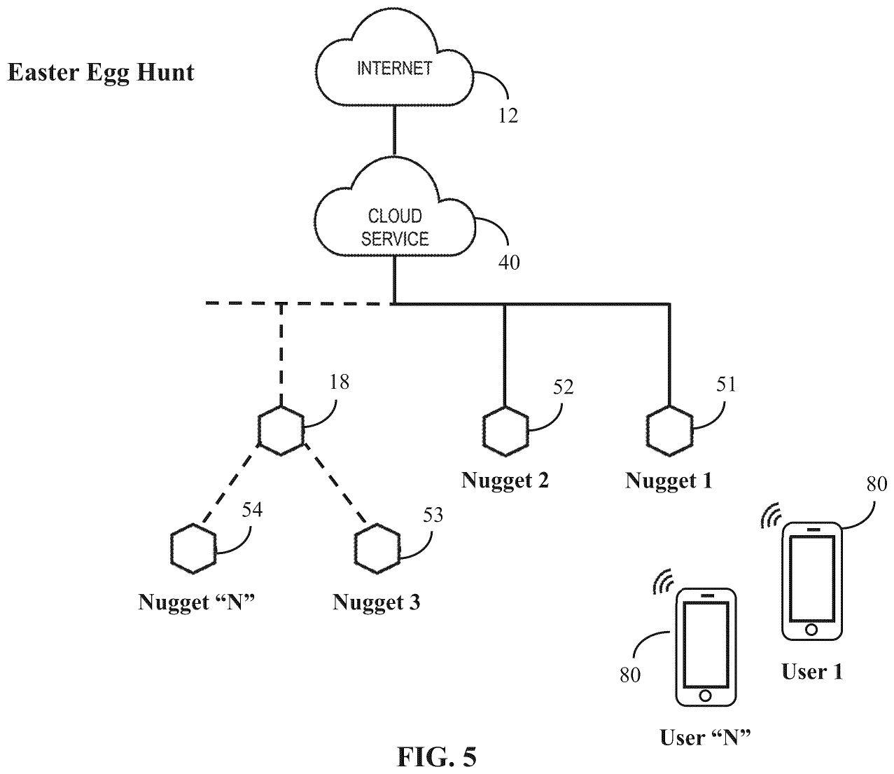

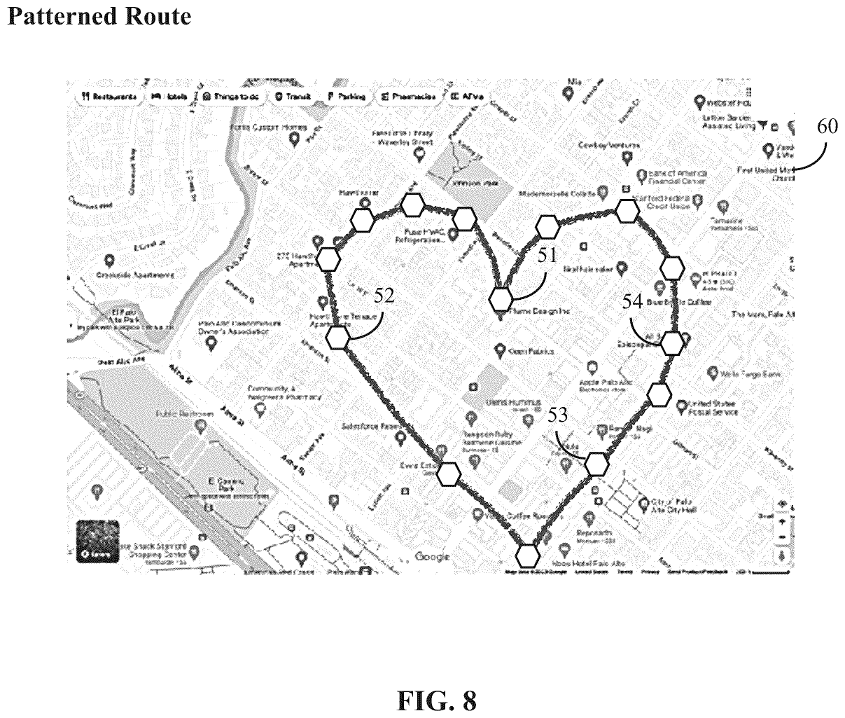

Referring to FIG. 5, the system infrastructure comprises access points (APs) 51-54, such as those provided by Plume Design Inc., for example, which are configured to create a mesh network across a geological location 60, as depicted in FIG. 8, for example. In some embodiments, each AP has the capacity to generate a primary and secondary Wi-Fi network, distinguished by unique Service Set Identifiers (SSIDs). The primary network is encrypted and secured for exclusive use by the homeowner, while the secondary network is open for guests and supports the gaming ecosystem according to some embodiments.

In some embodiments, the secondary network is utilized to broadcast specific SSIDs that serve as ‘nuggets’ or ‘clues’ for games. According to some embodiments, these nuggets include virtual objects that are associated with a physical location, enabling the system to create an augmented reality (AR) layer over the actual geological location 60. In some embodiments, cloud service 40 acts as the central server, managing the game logic, player interactions, and data analytics.

In some embodiments, users interact with the system via a smartphone application, which serves as the gaming interface. HomePass® by Plume Design Inc. serves as a suitable application to host the system games described herein. The app detects the presence of game-related SSIDs as players move throughout the geological location. In some embodiments, the smartphone's Wi-Fi connectivity is used to establish a connection to the secondary network, upon user consent, enabling the game interactions. In some embodiments, the app is configured to communicate with cloud service 40 to record the player's location and/or actions during the game.

FIG. 5 illustrates an Easter Egg Hunt game according to some embodiments. In some embodiments, participants use the HomePass app on their smartphones to locate and collect virtual easter eggs. Each egg is associated with a secondary Wi-Fi network named with a distinctive nugget identifier, like ‘EasterEgg01’, ‘EasterEgg02’, etc. As players travel through the geological location 60, the app configuration scans for these SSIDs. When a player's smartphone comes into the range of an SSID broadcasting a nugget, the app prompts the user to connect. Upon connection, the app automatically logs the event, awards points to the player, and updates a centralized leaderboard hosted on cloud service 40. FIG. 8 shows a non-limiting leaderboard 70 according to some embodiments. In some embodiments, the app is configured to provide hints and notifications to guide players to nearby easter egg locations, encouraging exploration and physical movement.

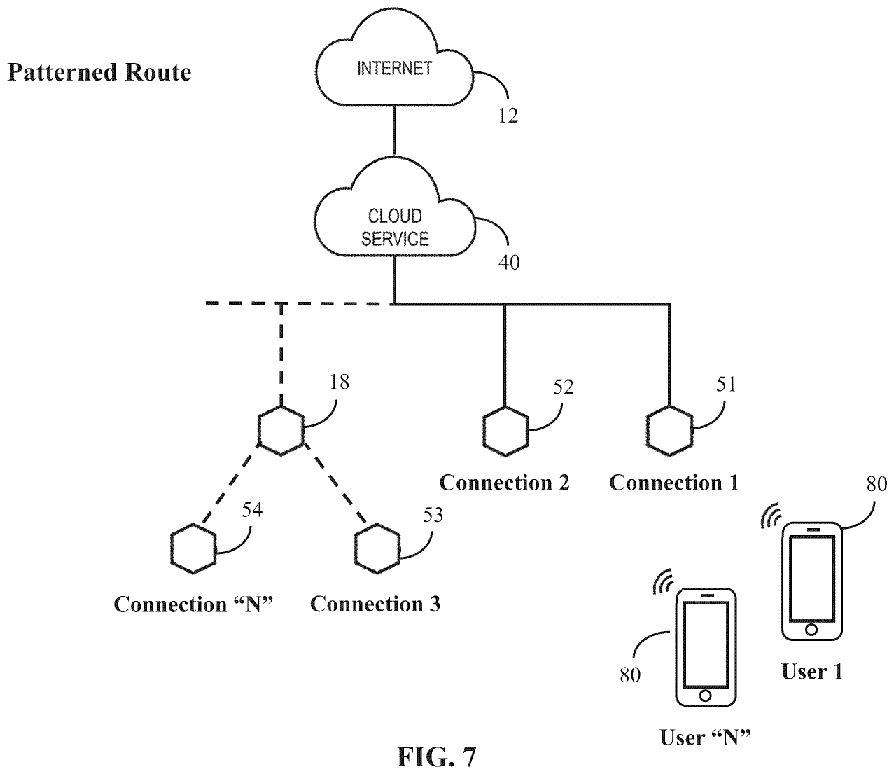

In some embodiments, the app is configured to enable a user to create a game. In some embodiments, a system executed program step includes generating a map of a geological location. Some embodiments include a step to display, by one or processors, a secondary SSID network availability, where the availability may be overlaid on the map. In some embodiments, a step includes generating an input for a user to select one or more nodes for the game. Once one or more nodes are selected, the system is configured to enable a user to configure the SSID to broadcast game data, which may include nuggets, clues, connection points, rules, invites, and/or any other information, collectively referred to herein as “elements”. In some embodiments, the system is configured to enable a user to select nodes by moving through a geographical area, where the system is configured to automatically store nodes with sufficient strength to enable the game. Node selection for games is discussed further in relation to FIGS. 7 and 8.

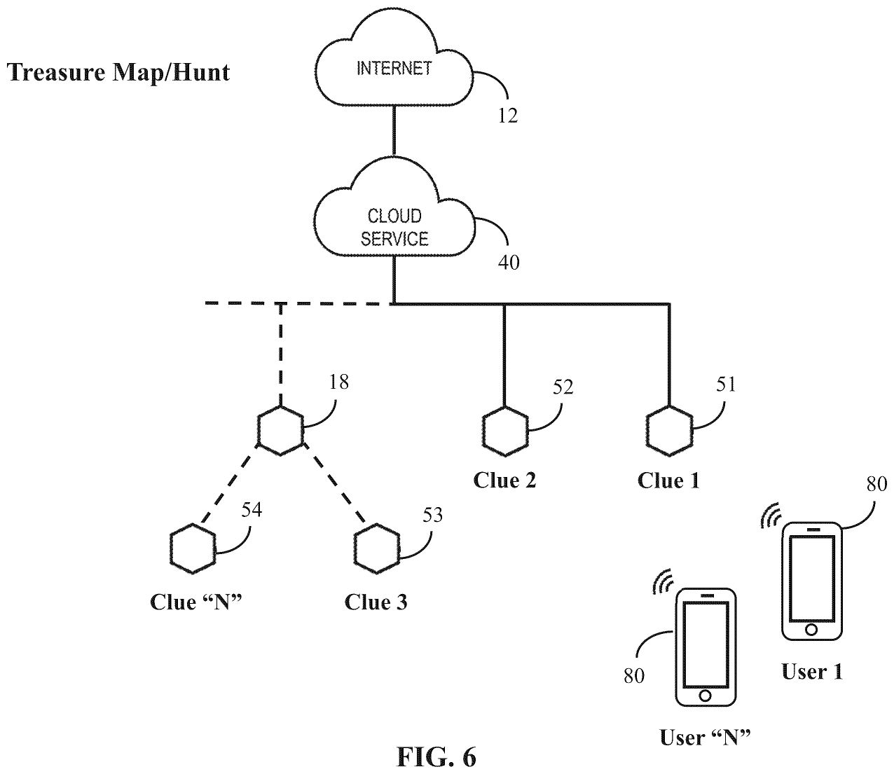

As shown in FIG. 6, a Treasure Map/Hunt game expands upon the Easter Egg Hunt concept by incorporating a series of clues leading to a final treasure. In some embodiments, each clue is represented by a unique SSID, such as ‘TreasureClue01’, broadcasted by the secondary Wi-Fi networks. Players receive the first clue via the app, which leads them to the location of the first Wi-Fi node. When the player arrives and connects to the node, the system is configured to unlock the next clue in the app. This sequential unlocking of clues requires players to traverse different areas, potentially over a wide geographic span, engaging with multiple Wi-Fi nodes, and piecing together the map that leads to the treasure.

Referring again to FIG. 7, in some embodiments, a Patterned Routes game allows players to create and follow geo-artistic patterns by connecting to a sequence of non-primary SSIDs assigned to various nodes. Each node's SSID, such as ‘GeoPattern01’, corresponds to a virtual ‘point’ on the pattern map visible within the app. In some embodiments, the system is configured to enable players to create a route by connecting to nodes in a specific order using a graphical user interface (GUI) generated by the app, creating patterns that are overlaid on real-world maps within the app interface, as illustrated in FIG. 8. In some embodiments, the system is configured to share creative patterns on a community leaderboard, where other players can view and vote on the patterns via a vote input on the GUI. This voting system not only encourages community engagement but also promotes the creation of intricate and visually appealing patterns, adding a competitive and artistic element to the physical activity of walking or running the routes.

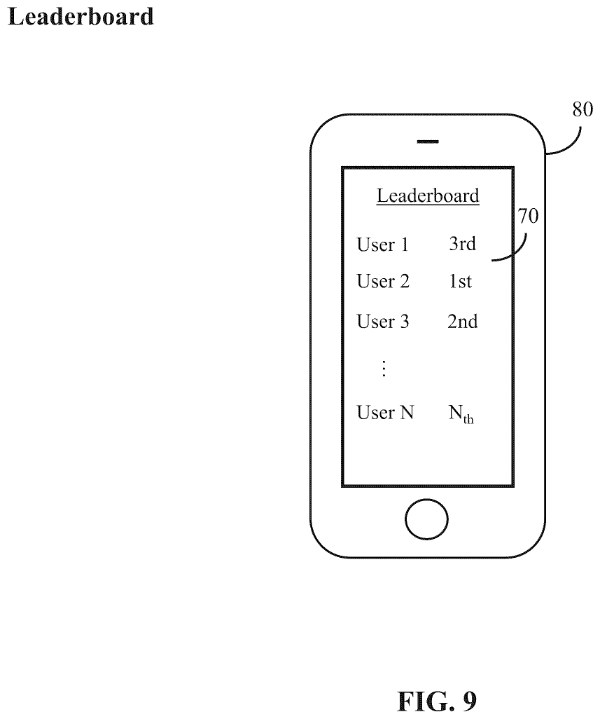

Computer implemented algorithm steps include initiating gameplay by launching the app on a smartphone 80 (see FIG. 9), where the system is configured to begin searching for game-related SSIDs in the vicinity of the smartphone 80. In some embodiments, the user's movement through the geographical location prompts the app to alert them of nearby game elements based on their location and the availability of the corresponding SSIDs. As the player interacts with each game element, which can include collecting an easter egg, following a treasure hunt clue, or creating a geo-pattern, as non-limiting example, actions are synchronized in real-time with the cloud service 40, which tracks progress and updates the relevant leaderboards 70 as previously described.

In some embodiments, a smartphone's Wi-Fi capabilities are used for detecting and connecting to the secondary Wi-Fi networks that serve as interactive game stations. GPS functionality enhances the gaming experience by enabling precise geolocation, while the smartphone's display presents the AR overlay, game notifications, and leaderboards, facilitating a seamless and engaging user interface.

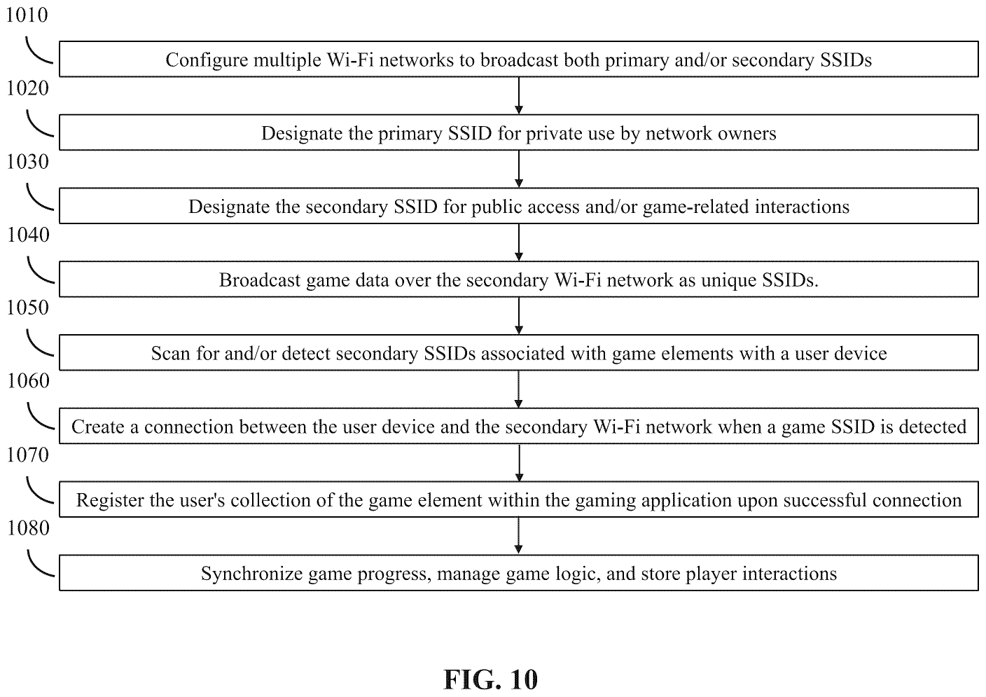

FIG. 10 is a visual representation of one or more algorithmic steps implemented by the system. In accordance with some embodiments described herein, the system executes a series of computer-implemented steps to enable a variety of Wi-Fi-based games, leveraging the presence of Wi-Fi networks to create an interactive and physically engaging gaming experience. At step 1010, the system is configured to initialize the gaming infrastructure by setting up multiple Wi-Fi networks capable of broadcasting distinct primary and secondary Service Set Identifiers (SSIDs). As shown in step 1020, the primary SSID is secured for exclusive use by the network owner, while the secondary SSID is allocated for public access and is utilized for broadcasting game-related data as shown in step 1030. Step 1040 includes broadcast game data, such as game elements including virtual items or objectives, over the secondary Wi-Fi network as unique SSIDs.

The system further includes a gaming application on user devices, which is programmed to detect secondary SSIDs associated with these game elements at step 1050. Upon detection at step 1050, the application establishes a connection between the user device and the secondary Wi-Fi network at step 1060. Once a connection is made, the system registers the acquisition of the game element within the user's gaming application and updates the player's in-game progress accordingly as shown in step 1070. To ensure a seamless gaming experience, the system communicates with a central server or cloud service, synchronizing game progress, managing game logic, and recording player interactions at step 1080.

In some embodiments, the system is configured to receive geolocation data from user devices 80 to provide location-based challenges, thereby enhancing the interactive gaming experience. In order to support stable and efficient data transmission for gameplay, the system optimizes Wi-Fi network configurations, which may include access points, mesh nodes, and repeaters. The system is further configured to collect signal strength data from various Wi-Fi networks to determine the effective broadcast range of game elements, enabling the generation of a virtual map overlay that indicates the locations of available game elements.

In some embodiments, the system provides a platform for users to create, configure, and share their own games and game elements with other players. It also updates a centralized leaderboard with player achievements and rankings based on in-game progress. Additionally, the system is configured to push notifications and hints to user devices to assist players in locating and interacting with game elements.

Community features are implemented within the system, allowing for user engagement, such as voting on user-generated content or participating in shared game experiences. In some embodiments, the system manages and monitors the performance of the Wi-Fi network infrastructure to ensure optimal conditions for gameplay, thereby providing an immersive gaming experience while simultaneously encouraging physical activity and combating the sedentary tendencies of traditional video games. The disclosure describes the specifics of how a machine including one or more computers comprising one or more processors and one or more non-transitory computer readable media implements the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations thereof (e.g., the system display can show X) are used for descriptive purposes only and are understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications, and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

We claim:

1. A method comprising steps of:
configuring each a plurality of Wi-Fi networks to broadcast a primary Service Set Identifier (SSID) and at least one secondary SSID;
designating the primary SSID for use by a network owner and the at least one secondary SSID for broadcasting game data;
enabling a gaming application on a user device to detect the at least one secondary SSID associated with the game data;
establishing a connection between the user device and a secondary Wi-Fi network associated with the at least one secondary SSID;
broadcasting the game data over the secondary Wi-Fi network associated with the at least one secondary SSID; and
registering an acquisition of the game data within the gaming application upon the connection to the secondary Wi-Fi network.

2. The method of claim 1, further comprising a step of:
communicating with a central server and/or cloud service to synchronize game progress and/or manage game logic.

3. The method of claim 1, further comprising a step of:
receiving geolocation data from the user device; and
using the geolocation data to provide geolocation-based games.

4. The method of claim 1, further comprising a step of:
collecting signal strength data from Wi-Fi networks to determine an effective broadcast range of game data.

5. The method of claim 4, further comprising a step of:
generating a virtual map overlay indicating locations of available game data based on the collected signal strength data.

6. The method of claim 1, further comprising a step of:
providing a platform for users to create, configure, and share user games and/or game data with other players.

7. The method of claim 1, further comprising a step of:
updating a centralized leaderboard with player achievements and rankings based on in-game progress.

8. The method of claim 1, further comprising a step of:
pushing notifications and hints to user devices to assist players in locating and interacting with the game data.

9. The method of claim 1, wherein the game data includes virtual items and/or objectives.

10. The method of claim 1, further including a step of:
designating the primary SSID for private use by the network owner.

11. A system comprising:
a plurality of Wi-Fi networks configured to broadcast a primary Service Set Identifier (SSID) and a secondary SSID;
a gaming application on a user device programmed to detect the secondary SSID associated with a game;
a central server and/or cloud service configured to synchronize game progress and manage game data; and
geolocation tracking software configured to track a location of the user device during the game;
wherein the game requires that the user device to be transported from one location to another to detect the secondary SSID as part of the game.

12. The system of claim 11, wherein the game data includes virtual items or objectives.

13. The system of claim 11, wherein the system is configured to determine an effective broadcast range of game data.

14. The system of claim 11, wherein the system is further configured to generate a virtual map overlay indicating locations of available game data.

15. The system of claim 11, further comprising a user application configured to enable users to create, configure, and/or share custom games and/or custom game data.

16. The system of claim 11, wherein the system is configured to update a leaderboard with player achievements and/or rankings based on in-game progress.

17. The system of claim 11, wherein the game includes colleting nuggets by moving the user device to within range of the secondary SSID.

18. The system of claim 11, wherein the game includes collecting clues by moving the user device to within range of the secondary SSID.

19. The system of claim 11, wherein the game includes generating a pattern for a user to follow by moving the user device to within range of the secondary SSID.

20. A non-transitory computer-readable storage medium tangibly encoded with computer-executable instructions, that when executed by a processor, cause a computer to implement steps comprising:
configuring a plurality of Wi-Fi networks to broadcast distinct primary and secondary signals;
enabling a gaming application on a user device to detect a secondary signal associated with game data;
establishing a connection between the user device and a secondary Wi-Fi network upon detection of a game-related signal;
registering an acquisition of the game data within the gaming application upon the connection to the secondary Wi-Fi network using information from the secondary signal;
communicating with a central server and/or cloud service to synchronize game progress and manage game logic; and
receiving geolocation data from the user device to enable location-based games.
